(19) United States
(12) Patent Application Publication
(10) Pub. No.: US 2008/0098404 A1
(43) Pub. Date: Apr. 24, 2008

(54) INFORMATION PROCESSING APPARATUS, CONTROL METHOD FOR INFORMATION PROCESSING APPARATUS AND PROGRAM

(75) Inventors: Masaki Oi, Kawasaki (JP); Yoshinari Akakura, Kawasaki (JP); Kiyoshi Miyano, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kanagawa (JP)

(21) Appl. No.: 11/829,448

(22) Filed: Jul. 27, 2007

(30) Foreign Application Priority Data
Oct. 19, 2006 (JP) 2006-285343

(51) Int. Cl. G06F 9/46

(52) U.S. Cl. 718/105

(57) ABSTRACT

An information processing apparatus having a multitask operating system includes a high-load continuation detecting part detecting continuation of a high-load state of a CPU; a task switching history storing part storing a history of task switching operation; and a trouble task candidate extracting part extracting candidates for a trouble task which causes continuation of a high-load state of the CPU by referring to the history of the task switching operation stored by the task switching history storing part when the continuation of the high-load state of the CPU is detected by the high-load continuation detecting part.

### BACKGROUND OF THE INVENTION

1. Field of the Invention

The present invention relates to an information processing apparatus, a control method for the information processing apparatus and a program, and, in particular, to an information processing apparatus having a multitask operating system, a control method for the information processing apparatus and a program for causing a computer to execute the control method for the information processing apparatus.

2. Description of the Related Art

For example, as a method for detecting a state in which a CPU operates with a load of 100% continuously for a predetermined time as a trouble state in a computer system mounting a multitask operating system (simply abbreviated as ‘OS’, hereinafter), the following method may be applied. That is, in a program configured by a trouble monitoring task (highest priority level) and a trouble detecting task (lowest priority level), the determination is made as a result of the trouble monitoring task detecting that the trouble detecting task does not operate for a predetermined time (see Japanese Laid-Open Patent Application No. 2000-181755).

Further, when the state of continuation of the CPU's load of 100% occurs, it is expected that this state is caused as a result of a program operating on a task which ethers an infinite loop operation state. As a method for detecting the task which actually acts as the cause thereof, the following method may be applied. That is, when the trouble monitoring task (highest priory level) detects a trouble, a test is carried out not only on the trouble detecting task (lowest priority level) but also on all the other tasks, as to whether or not they operate properly, and thereby, the task actually acting as the cause of the trouble is identified (see Japanese Laid-Open Patent Application 10-11327).

In the above-mentioned method of Japanese Laid-Open Patent Application 2000-181755, as mentioned above, it is determined that a trouble has occurred, when the CPU is kept in a 100% load state for a predetermined time. However, actually, a case may be expected that, even when any infinite loop operation state has not actually occurred, the CPU's load temporarily becomes 100% due to processing which requires the CPU to operate with a high load. According to the above-mentioned method, even such a state may be determined as a trouble state erroneously. When such a program is provided that predetermined special recovery processing or such is started up automatically in response to the trouble detection, unnecessary recovery processing may have to be carried out.

When a task of a higher priority level enters a high load state, tasks of lower priority levels cannot operate accordingly. In such a case, a suspicious task may not be detected in the above-mentioned method of Japanese Laid-Open Patent Application No. 10-11327. Further, when a phenomenon (so-called ‘ping-pong phenomenon’) in which message exchange is carried out infinitely between a plurality of tasks occurs, these tasks enter high-load states accordingly, and thus, it is difficult to identify the actually suspicious one task.

Other than the above-mentioned Japanese Laid-Open Patent Applications Nos. 2000-181755 and 10-11327, Japanese Laid-Open Patent Applications Nos. 2000-267895, 2003-345629, 2005-063295 and 2006-011686 relate to the present invention.

### SUMMARY OF THE INVENTION

The present invention has been devised in consideration of these situations, and an object of the present invention is to provide a configuration by which, for a multitask operating system, a trouble task can be detected with a high accuracy.

According to the present invention, a high-load continuation detecting part detecting continuation of a high-load state of a CPU; a task switching history storing part storing a history of task switching operation; and a trouble task candidate extracting part extracting candidates for a trouble task which causes the continuation of the high-load state of the CPU, by referring to the history of the task switching operation stored by the task switching history storing part, when the continuation of the high-load state of the CPU is detected by the high-load continuation detecting part, are provided.

In this configuration, when the high-load continuation detecting part detects CPU's high-load state continuation, a task switching operation history stored by the task switching history storing part is referred to. Thereby, candidates for the trouble task are extracted, which actually acts as a cause of the above-mentioned CPU's high-load state continuation. Thus, it is possible to narrow down the trouble tasks candidates. By thus narrowing down the trouble task candidates, after that, it is possible to monitor only these narrowed down trouble task candidates in a concentrated manner. Thus, it is possible to positively and efficiently detect the trouble task.

Thus, according to the present invention, it is possible to effectively narrow down the candidates for the trouble task, after that, it is possible to carry out continuous monitoring only the thus-narrowed down trouble task candidates. As a result, it is possible to achieve positive and efficient detection of the trouble task.

### BRIEF DESCRIPTION OF THE DRAWINGS

Other objects and further features of the present invention will become more apparent from the following detailed description when read in conjunction with the accompanying drawings:

FIG. 1 shows a diagram for illustrating task control for a multitask operating system;

FIG. 2 shows a diagram for illustrating application of an embodiment of the present invention to a configuration shown in FIG. 1;

FIG. 3 shows a transition diagram illustrating task execution states;

FIG. 4 shows a diagram illustrating a message queue and inter-task message transmission/reception state;

FIGS. 5 and 6 show diagrams for illustrating correlation relationship among respective functions of the embodiment of the present invention;

FIG. 7 shows a diagram for illustrating inter-task message transmission/reception state in a so-called ping-point phenomenon;

FIG. 8 shows a diagram for illustrating a function 1 of the embodiment of the present invention;

FIG. 9 shows an operation flow chart for illustrating operation of a monitoring task for carrying out the function 1;

FIG. 10 shows an operation flow chart for illustrating operation of a detecting task for carrying out the function 1;

FIG. 11 shows a diagram for illustrating history information obtained by a function 2 of the embodiment of the present invention;

FIG. 12 shows an operation flow chart for illustrating operation of the function 2;

FIG. 13 shows a diagram for illustrating history information analysis processing for when suspicious tasks are extracted by a function 3 of the embodiment of the present invention;

FIG. 14 shows an operation flow chart for illustrating operation of the function 3;

FIG. 15 shows an operation flow chart for illustrating operation of the function 4;

FIG. 16 shows a diagram for illustrating history information obtained by a function 5 of the embodiment of the present invention;

FIG. 17 shows an operation flow chart for illustrating operation of the function 5;

FIG. 18 shows an operation flow chart for illustrating operation of a function 6 in the embodiment of the present invention;

FIG. 19 shows an operation flow chart for illustrating operation of trouble responding processing in the embodiment of the present invention; and

FIG. 20 shows a block diagram of one example of a hardware configuration of an information processing apparatus in the embodiment of the present invention.

### DETAILED DESCRIPTION OF THE PREFERRED EMBODIMENT

With reference to figures, an embodiment of the present invention will now be described.

A trouble task detecting program as an embodiment of the present invention provides a function to detect a state that an application program operating on a multitask OS, which has such a function that a plurality of tasks having respective priority levels operate, enters an infinite loop operating state by some cause.

That is, according to the embodiment of the present invention, when a CPU's 100% load state occurs continuously upon operation of the multitask OS, it is possible to determine whether a cause thereof is illegal operation (infinite loop operation or such), or is merely temporary continuation of a high load state due to regular high load processing. Then, when it is determined that illegal operation of the program has caused the situation, tasks which are candidates of the actual cause thereof (refereed to as ‘suspicious task’, hereinafter) are specified.

Further, when it is determined that the illegal operation has caused the situation, a notification is generated externally that a trouble state has occurred.

Further, when it is determined that the illegal operation has caused the situation, a countermeasure thereto is selected, and is set.

Further, when a continuation of a high-load state is detected, information of the task acting as the cause thereof or candidates thereof is obtained as a history, and after that, the history is readable.

Further, when a continuation of a high-load state is detected, and also, this situation does not corresponds to a temporary event caused by regular high-load processing but corresponds to an event in which data exchange continues infinitely between a plurality of tasks, i.e., so-called ping-pong phenomenon, this fact is detected.

In the embodiment of the present invention, it is assumed that the OS has the following four functions i), ii), iii) and iv):

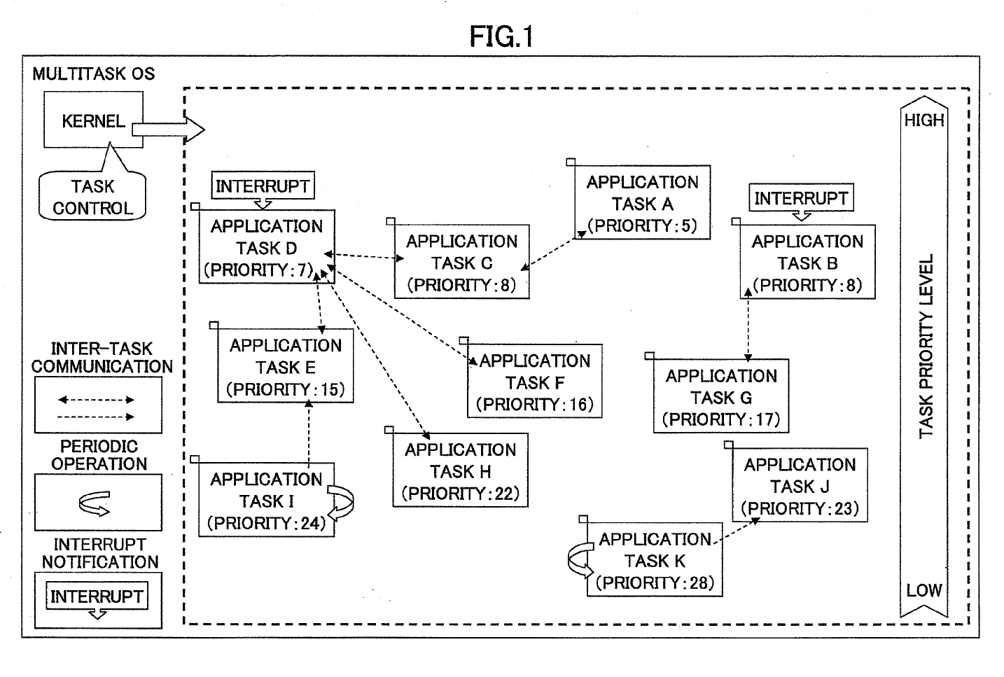

i) The respective tasks are executed according to their predetermined task priorities (see FIG. 1, i.e., a task scheduler function);

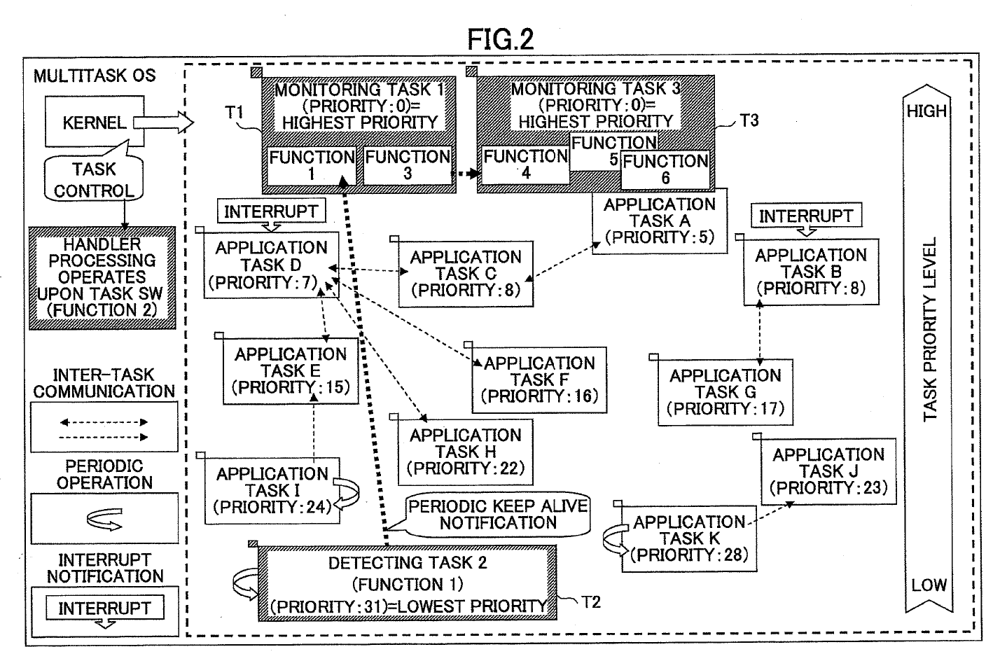

ii) When switching of the task to be executed (so-called ‘task switching’) has occurred, the corresponding task is identified (in FIG. 2, a function 2);

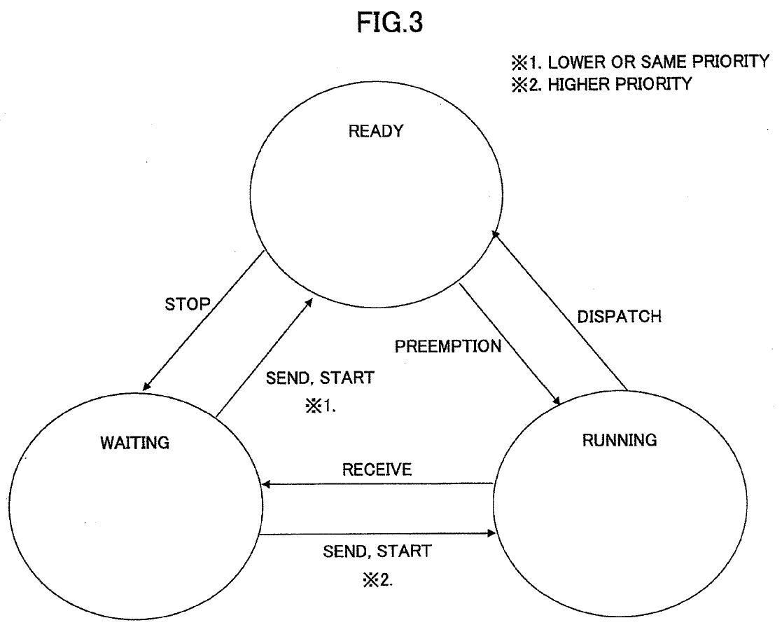

iii) A currently executed state of the task is obtained (see FIG. 3); and

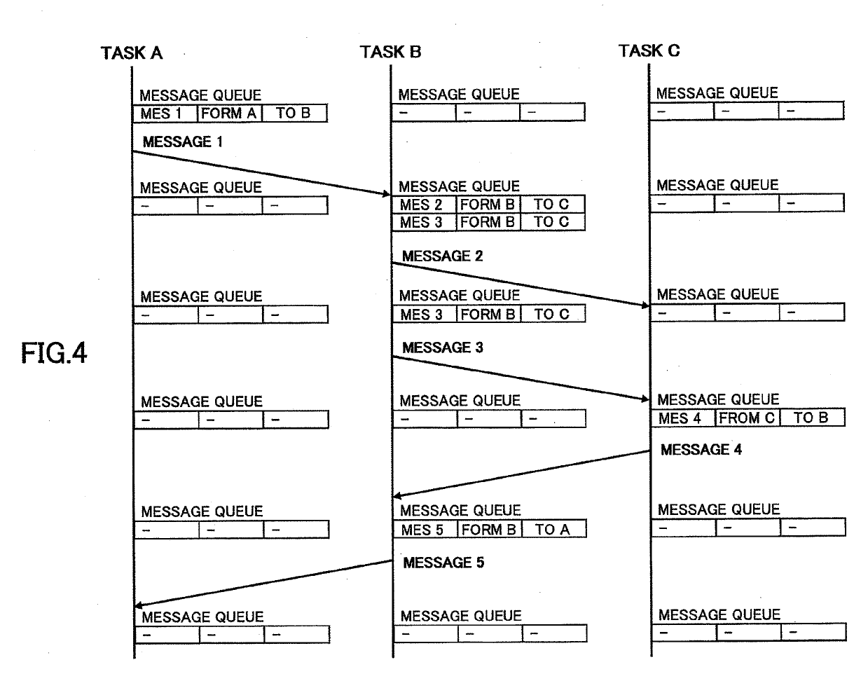

iv) A message transmission/reception state between the tasks (see FIG. 4) is obtained.

The above-mentioned function i) corresponds to such a function that, when the task priority is previously given to each task, each task (i.e., an application task) operates according to the priority.

The above-mentioned function ii) corresponds to the function 2 of FIG. 2, and corresponds to a function which executes corresponding handler processing which is previously registered, when task switching has occurred (also described later as the description of the function 2).

The above-mentioned function iii) corresponds to a function determining which of predetermined three types of execution states the currently executed task belongs to (see FIG. 3). The predetermined three types of execution states include a ‘state upon execution’ (Running); a ‘state executable’ (Ready); and a ‘state waiting for execution’ (Waiting).

For FIG. 3, each term has the following meaning:

Dispatch: operation of giving an execution right, thereby causing another task to enter a state upon execution, and entering itself a state executable.

Preemption: operation of receiving the execution right and entering a state upon execution.

Receive: operation of entering a state waiting for execution for waiting for receiving a message.

Send, Start: operation of a task in a state waiting for execution transmitting a predetermined message, and entering a state executable or a state upon execution.

Stop: operation of entering a state waiting for execution from a state executable in a predetermined condition.

Each task state will now be described:

State upon execution (Running):

A task which can enter the Running state within a given time is only one, for one processor;

The task in the Running state executes an instruction of a given program.

The task scheduler causes the task to wait until there are no tasks in the Ready states having the priority higher than the currently executed task.

The task scheduler carries out context switch (i.e., task switching) immediately when another task having the higher priority enters the Ready state, and thus, the task having the higher priority is to be executed earlier.

When the currently executed task is blocked by a system call or such, the process state is changed in the Waiting state. At this time, the scheduler selects the task having the higher priority, causes the same to enter the Ready state, and also, causes the same to be executed.

State executable (Ready):

The task is executed when all the tasks having the higher priorities have finished.

State waiting for execution (Waiting):

The task in the Waiting state either waits for occurrence of a specific event, or has already entered a stop state.

The task in the Waiting state does not require the CPU in this stage.

A system call causing the task to enter the Waiting state is called a blocking system call.

The task may enter the Waiting state by the following reasons:

1) It waits for arrival of a signal message;

2) It waits for elapse of a predetermined delay time;

3) It waits for a semaphore;

4) It waits for a high-speed semaphore;

5) It waits for completion of the system call;

6) It has been explicitly stopped by the system call (‘suspend’ or such);

7) It has reached a breakpoint.

Next, an example of transition of the task state will be described for each case:

Transition from the Running state:

Running→Ready (an arrow of Dispatch in FIG. 3):

When the task of the higher priority than that of the own task currently executed is executed, the execution right is dispatched thereto.

Running→Waiting (an arrow of Receive)

It occurs when the currently executed task enters the signal message waiting state, the delay time elapse waiting state, the semaphore waiting state or such.

Transition from the Ready state:

Ready→Running (an arrow of Preemption)

The execution right is preempted when there is no tasks in the Running/Ready states of the higher priorities than that of the own task currently executed.

Ready→Waiting (an arrow of Stop)

When the task in the Ready state is forcibly suspended by means of the system call, the task enters the Waiting state (the suspended task returns to the original state when being resumed).

Transition from the Waiting state:

Waiting→Running (an arrow of Send, Start):

When the own task is in the message waiting state and has the priority higher than that of the currently executed process (in the Running state), and then, the other task sends the message which the own task receives, or the task itself is created or started (create&start), the own task enters the Running state.

Waiting→Ready (an arrow of Send, Start):

When the own task is in the message waiting state and has the priority lower than or the same as that of the currently executed task (in the Running state), and then, the other process sends the message which the own task receives, or the task itself is created or started (create&start), the own task enters the Ready state.

The above-mentioned function iv) corresponds to a function to obtain information (a message queue or such) such as a message destination, during message transmission/reception between the tasks, such as that shown in FIG. 4.

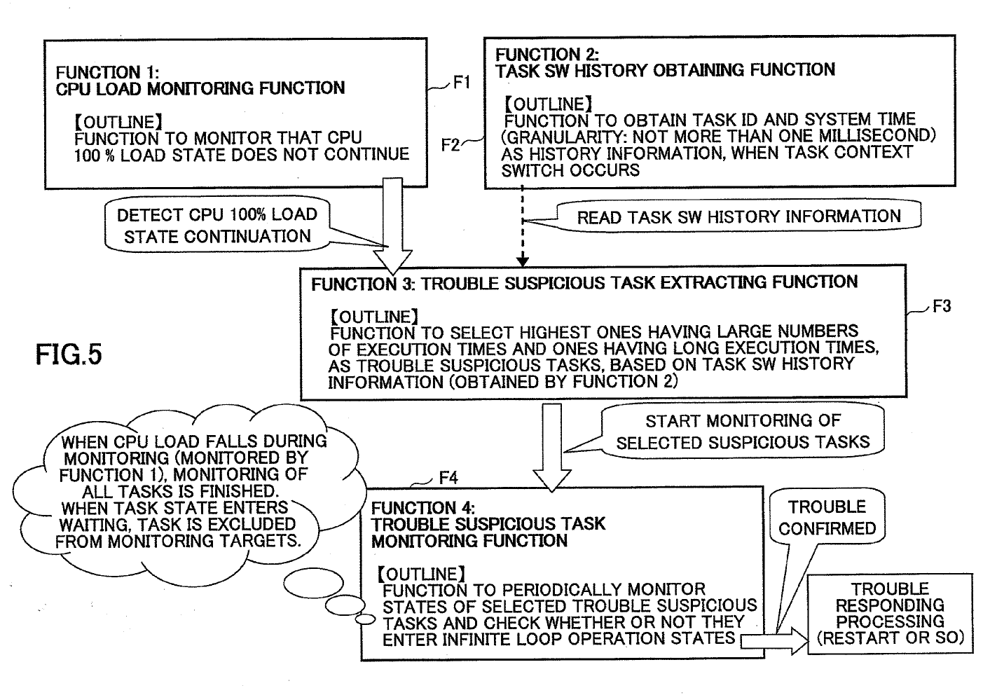

The trouble task detecting program according to the embodiment of the present invention is configured to have instructions to cause a computer to execute the following functions 1 (F1), 2 (F2), 3 (F3) and 4 (F4). FIG. 5 shows a relationship thereamong.

Function 1: CPU load monitoring function;

Function 2: task switching history obtaining function;

Function 3: trouble suspicious task extracting function; and

Function 4: trouble suspicious task monitoring function

The function 1 monitors whether or not the CPU's 100% load state continues, and, executes processing of the function 3 when detecting that the CPU's 100% load state continues more than a predetermined time.

The function 2 is a function to obtain a corresponding task ID and system time (ideally, granularity thereof being not more than 1 millisecond) as history information at the time when task switching has occurred.

The function 3 is started up when the function 1 has detected the CPU's 100% load state continuation for the predetermined time, and, based on the history information obtained by the function 2, the function 3 extracts the tasks which are highest ones in a list of those having values more than a predetermined threshold, i.e., those of larger numbers of execution times, those of longer execution times, or such, as the suspicious tasks for the trouble task. When there are no tasks of more than the above-mentioned predetermined threshold, execution of the function 1 is returned to.

The function 4 periodically monitors the execution states of the suspicious tasks extracted by the function 3 for a predetermined time, and checks whether or not an infinite loop operation state has occurred there.

When the function 4 has not found that the suspicious tasks enter the states waiting for execution, this means that the suspicious tasks have not released their execution rights. Accordingly, the function 4 determines that these tasks has entered the infinite loop operation states, and thus, executes predetermined trouble responding processing, i.e., restarts the corresponding tasks, carries out system restart, or such.

On the other hand, when it can be determined that the suspicious tasks have entered the states waiting for execution, it is determined that these tasks have not entered the infinite loop operation states, and thus, remove them from the monitoring targets. That is, these tasks are excluded from the suspicious tasks.

When there are thus no suspicious tasks to be monitored, the function 4 is finished. Further, when the function 1 has detected that the CPU load falls during the monitoring by the function 4, the function 4 is also finished.

Further, when the function 4 has found the tasks entering the infinite loop operation states, the function 4 notifies of this fact externally. That is, output to a console or such, is carried out.

Furthermore, when the function 4 has found the tasks entering the infinite loop operation states, the trouble responding processing for recovery of the tasks may be selected.

Further, a function 5, i.e., a suspicious task history obtaining function, is provided such that, while the function 4 stores the information of the tasks extracted as the suspicious tasks as the history, the same may be read by the function 5 according to a predetermined command or such.

When all the extracted tasks are excluded from the suspicious tasks and also the function 1 detects that the CPU's 100% load state continues for a long time during the monitoring operation by the function 4, there is a possibility that the above-mentioned ping-pong phenomenon has occurred rather than the infinite loop operation states of the specific tasks. Therefore, the task which executes the function 4 is provided with the following function 6, i.e., a ping-pong phenomenon monitoring function, by which existence/absence of the ping-pong phenomenon is determined.

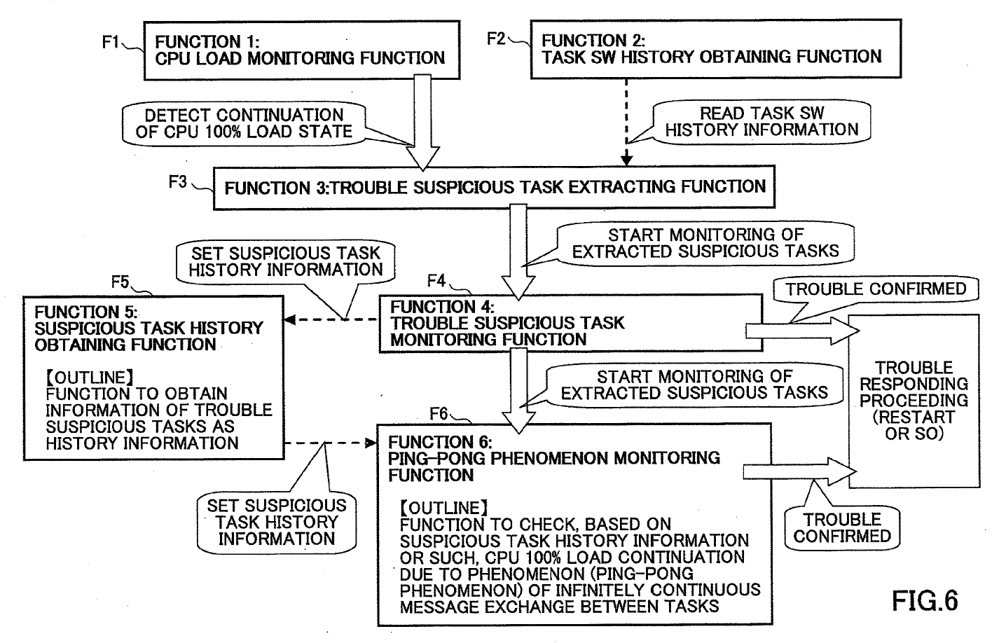

FIG. 6 shows relationship among these functions 1 through 6 (F1, F2, F3, F4, F5 and F6 of FIGS. 5 and 6).

The function 6 reads the history information of the suspicious tasks obtained by the function 5, and, when the plurality of tasks appear in the history, the function 6 reads the message transmission/reception states (i.e., the message queue information or such) of these suspicious tasks. Thus, it is determined whether or not the destinations of the messages are those between the suspicious tasks. When it is determined, as a result, that the message transmission/reception by the suspicious tasks corresponds to the message transmission/reception between the suspicious tasks, it is determined that a program trouble has occurred due to a ping-pong phenomenon. As a result, the predetermined trouble responding processing, such as system restart or such, is carried out.

By providing the above-described configuration according to the embodiment of the present invention, the trouble task detecting program according to the embodiment of the present invention provides the following advantages:

That is, in the related art, when a CPU enters a high-load situation, erroneous determination that a trouble has occurred may be made as mentioned above. In contrast thereto, according to the present embodiment, it is possible to determine, with a high accuracy, whether or not the CPU high-load state continuation corresponds to merely a temporary event caused by regular high-load processing, or corresponds to actually problematic high-load state continuation due to the program trouble such as the ping-pong phenomenon.

Further, in the related art, even when the high-load state continuation due to the ping-pong phenomenon has actually occurred, it may not be possible to positively distinguish it from a temporary high-load state due to regular high-load processing. In contrast thereto, according to the embodiment, it is possible to accurately detect the program trouble due to the ping-pong phenomenon.

The above-mentioned ping-pong phenomenon will now be described in detail.

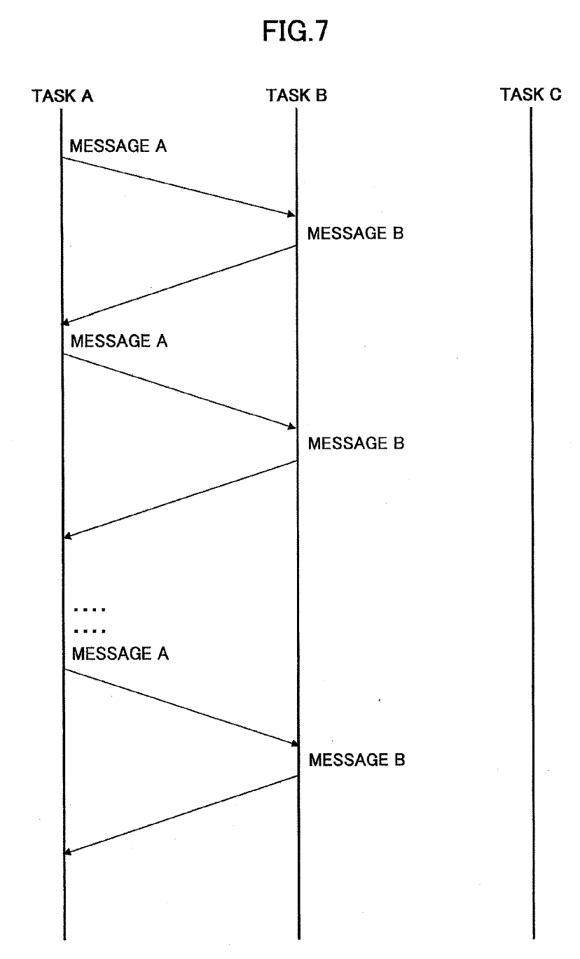

For example, as shown in FIG. 7, it is assumed that such a configuration is provided that, when a message A is transmitted from a task A to a task B, the task B having received it then transmits a message B to the task A. In such a case, when such operation occurs by some cause that the task A transmits the message B to the task B successively, the message exchange between the tasks A and B continues infinitely. Such a phenomenon is called a ping-pong phenomenon.

Next, the above-mentioned respective functions of the trouble task detecting program according to the embodiment of the present invention will be described in further detail.

The function 1 (F1) determines whether or not the CPU's 100% load state continues.

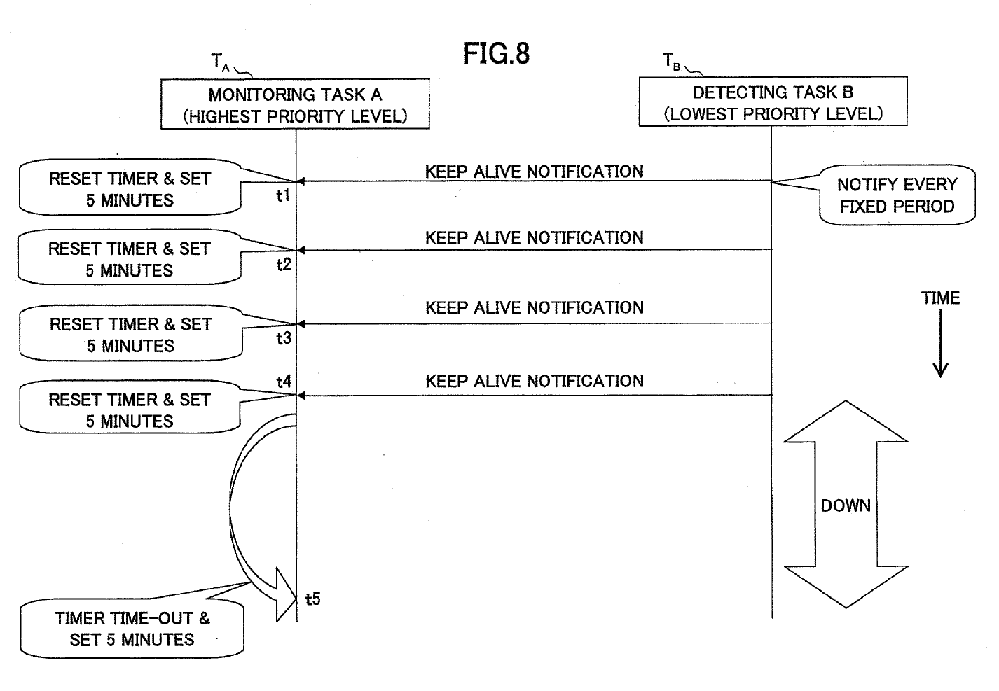

This operation is, as illustrated in FIG. 8, executed by a monitoring task A (i.e., TA corresponding to the task T1 of FIG. 2) of the highest priority and a detecting task B (i.e., TB corresponding to the task T2 of FIG. 2) of the lowest priority.

As shown in FIG. 8, the detecting task B periodically transmits a predetermined ‘keep alive’ notification to the monitoring task A. A transmission period of the keep alive notification may be set arbitrarily, and, in the embodiment, is set as every 10 second.

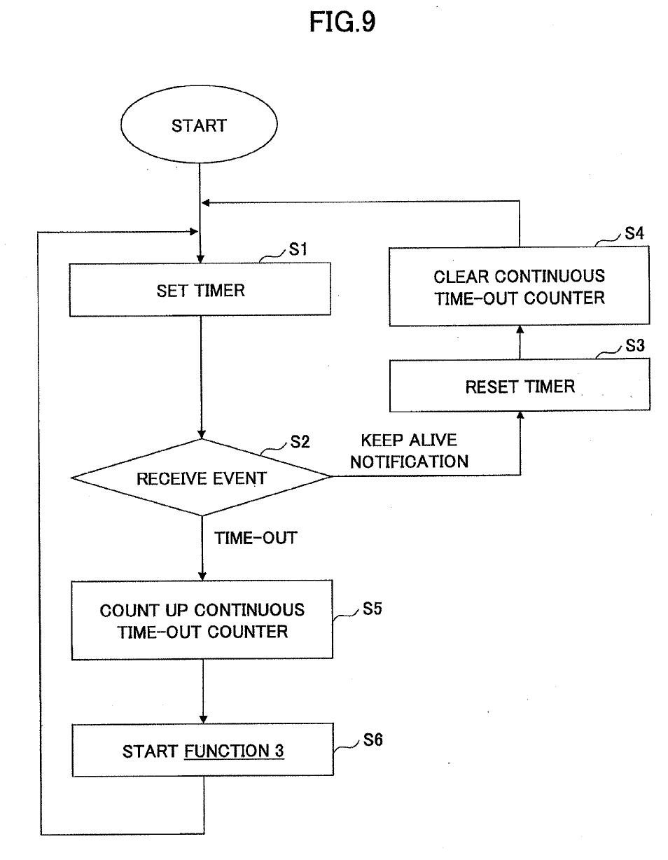

FIG. 9 shows a flow chart for illustrating the operation of the function 1 executed by the task A.

In FIG. 9, immediately after the task A is started up, a timer (in the example, a 5-minute timer; see FIG. 8) is started up (Step S1), a state in which the keep alive notification from the task B is waited for is entered (Step S2). After the notification has been received, the timer upon operation is reset immediately (Step S3). Then, after a predetermined continuous time-out counter is cleared (Step S4), the timer is again started (Step S1), and thus, the state of waiting for a response from the tasks B is entered again (Step S2).

On the other hand, when the timer outputs a time-out (‘time-out’ of Step S2), the continuous time-out counter counts up (Step S5), and the function 3 is executed (Step S6). It is noted that the task A executes the function 3.

In the example of FIG. 8, the monitoring task A receives the keep alive notification from the detecting task B at the time of t1, t2, t3 and then t4. Since, each time, the reception is made within the 5 minutes which is the set time of the timer, the timer is reset without outputting the time-out. After that, it is assumed that task switching stagnates by some cause and thus, timing of execution of the detecting task B of the lowest priority is delayed. In this case, after receiving the keep alive notification at the time of t5, the monitoring task A cannot receive the keep alive notification accordingly. As a result, after the elapse of the 5 minutes, the timer outputs the time-out (i.e., Step S2, time-out of FIG. 9).

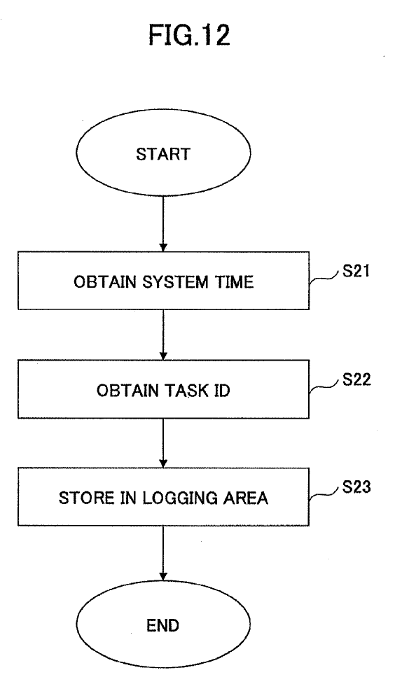

Next, in the above-mentioned function 2 (F2), all the logs are collected always when task switching occurs. This function is executed each time the task switching occurs, and operation shown in FIG. 12 is carried out.

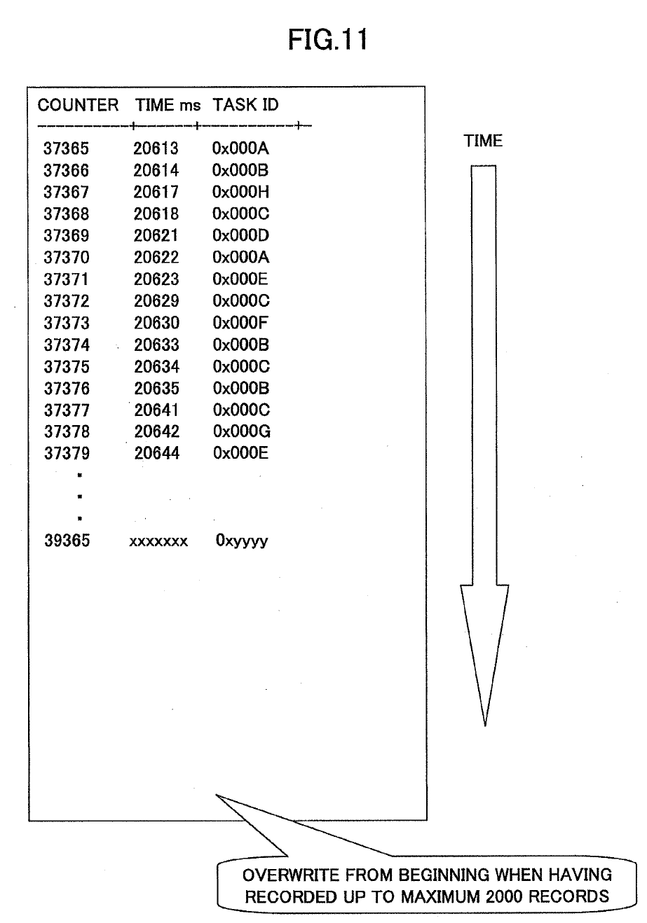

That is, being triggered by occurrence of the task switching, the system time (in the granularity of 1 millisecond) is obtained from the OS, and a corresponding task ID is obtained. Then, the thus-obtained information is recorded in sequence in a format shown in FIG. 11. A logging area for the recording in the format of FIG. 11 is of a capacity such as to be able to store maximum 2000 records (changeable). After the recording is made, up to the 2000 records, the first logging point is returned to. Thus, the recording is made cyclically in an endless manner.

This function 2 is executed by a handler function of the OS, i.e., for example, by a SwapIn handler function in a case of OSE (Office Server Extension). Accordingly, this function is not executed by the task but is started up and executed by the OS itself by means of the program function activity.

Next, assuming that the infinite loop operation states may have occurred on the specified task as a cause of the CPU's 100% load state continuation, the function 3 (F3) extracts corresponding candidates as the suspicious tasks.

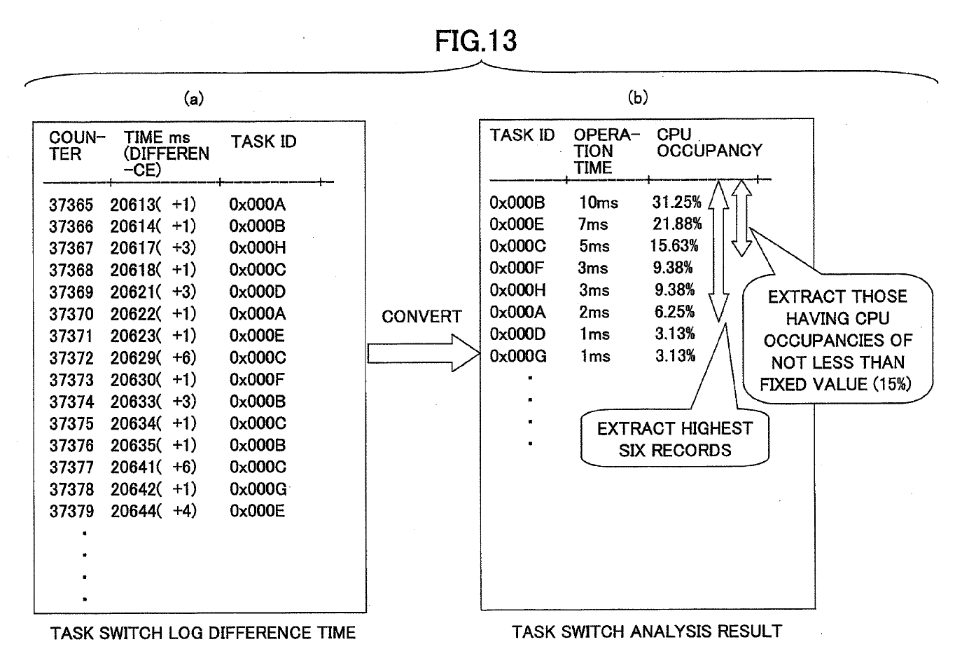

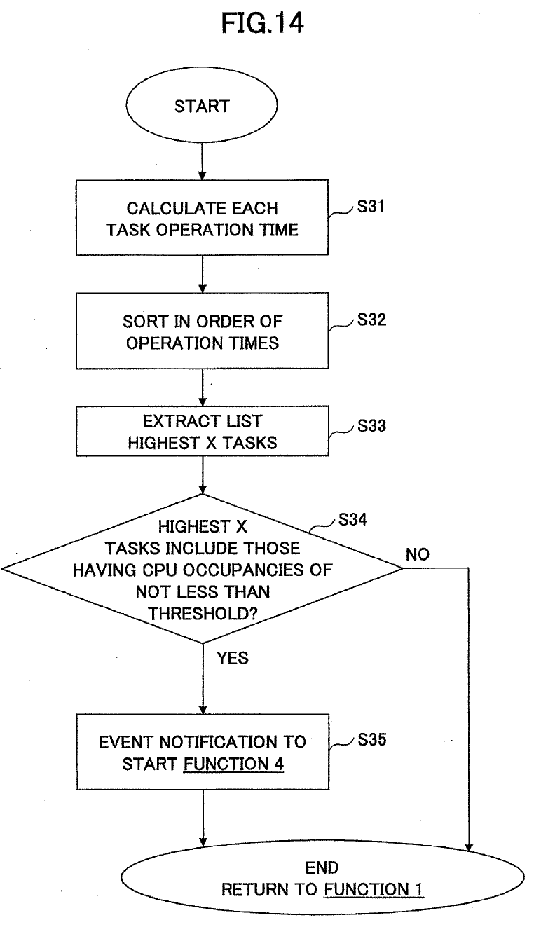

Specifically, a flow chart of FIG. 14 is executed. That is, immediately after the state where the function 3 is executed occurs (i.e., Step S6 of FIG. 9), the logs of the task switching obtained by the function 2 are read, and an operation time of each of the maximum 2000 tasks in total is calculated. The time calculation is actually carried out by a calculation of a time difference from the immediately preceding log. As shown in FIG. 13 (a), the calculation results are recorded in a list.

That is, from the maximum 2000 logs, a total operation time, which indicates how long time (milliseconds) each task has operated, is calculated, in task ID units (Step S31 of FIG. 12). Then, the total operation times of the respective tasks thus obtained are sorted in the order of the operation times (Step S32). FIG. 13 (b) shows an example where the total operation times have been calculated from the list of the difference times shown in FIG. 13 (a), and then, the calculation results are stored.

As shown in FIG. 13 (b), the highest six tasks (the actual number being changeable in consideration of the total number of tasks or such) are selected from the thus obtained list, as list highest tasks (Step S33). Further, from among these list highest six tasks, the IDs of those having the CPU occupancies of not less than 15% (i.e., a predetermined threshold; this value being also changeable) are extracted (Step S34). When no corresponding tasks occur, it is determined that no trouble has occurred but merely a regular over-load situation continues. Then, a state in which the function 1 is executed is returned to (No in Step S34).

On the other hand, when some corresponding tasks occur (Yes in Step S34), they corresponding to the suspicious tasks, a predetermined message is sent to another task (one corresponding to the task T3 in FIG. 2), by which the function 4 is executed.

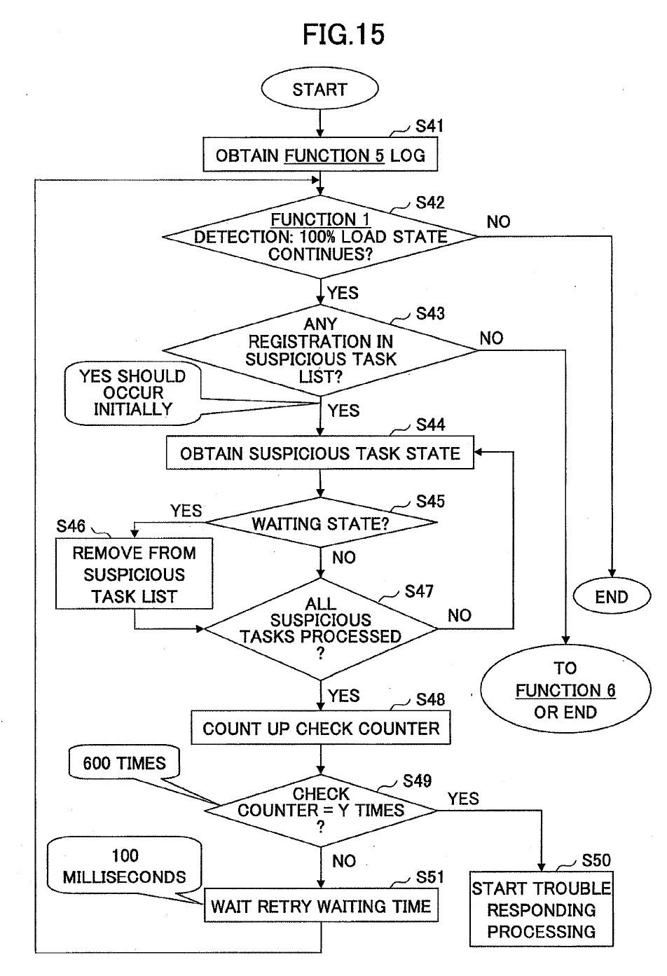

The function 4 is a function to determine whether or not the infinite loop operation state has occurred. The function 4 is executed with the priority higher than those of the application task group (see FIG. 2), and, operation of a flow chart of FIG. 15 is executed.

The task executing the function 4 is a separate task (one corresponding to the task T3 in FIG. 2) from the task A of the highest priority executing the functions 1 and 3. The task starts the operation of FIG. 15, being triggered by the above-mentioned message notification made by the task A.

Immediately after the start of the execution of the function 4, the information of the list of the suspicious tasks extracted by the function 3 as mentioned above is logged by the function 5 (Step S41). After the logging, it is determined whether or not the CPU's 100% load state monitored by the function 1 still continues. When it does not continue, it is determined that no mal-operation (illegal processing) such as the infinite loop operation or such has occurred, and merely a regular over-load situation has occurred. Then, the execution of the function 4 is finished (No in Step S41). On the other hand, when it is determined that the CPU's 100% load state still continues (Yes in Step S41), Step S43 is then executed.

In Step S43, the states of the suspicious tasks are obtained by the program function activity executed by the OS. For example, in the above-mentioned case of OSE, the function of get_pcb is used. The states of the tasks may be any ones of the above-mentioned three types, shown in FIG. 3, i.e., the states executable (Ready), the states upon execution (Running) and the states waiting for execution (Waiting). In Step S43, it is determined whether or not the tasks have entered the states waiting for execution (Waiting).

When the tasks are in the states waiting for execution (Yes in Step S45), this means that the corresponding tasks are in the states waiting for messages or such. As a result, it can be determined that no infinite loop operation has occurred. Accordingly, the tasks waiting for execution are excluded from the suspicious tasks, and thus, are excluded from those to be further monitored (Step S46).

When the corresponding tasks are in the states other than those waiting for execution, this means that these tasks continue operation. Accordingly, these tasks are left in the suspicious tasks (No in Step S45).

The same test is carried out on each of all the tasks included in the suspicious tasks (a loop of Steps S44 and S45 (as well as S46 if applicable)). After the test has been completed for all the suspicious tasks (Yes in Step S47), Step S48 is executed.

For all the suspicious tasks still left, a check counter is provided for each thereof, and it counts up by one. Next, in Step S49, it is determined whether or not the count value of each counter has reached a predetermined threshold, i.e., 600 times (changeable).

When there is the suspicious task having the count value of the check counter of 600 times (Yes in Step S49), this task is determined as the trouble task, and it is determined that the infinite loop operation has occurred by this task. Then, the predetermined trouble responding processing is started (Step S50).

On the other hand, when each suspicious task does not have the count value of the check counter of 600 times (No in Step S49), it is determined that the monitoring should be further continued. As a result, after an elapse of a predetermined retry time, i.e., 100 milliseconds (changeable) (Step S51), operation of the function 4 is carried out again from the beginning (Steps S42 through S49).

The test is thus repeated maximum 600 times every period of the above-mentioned 100 milliseconds. As a result, the test by the function 4 continues for total 1 minute.

A case can be assumed where the operation for the test by the function 4 is repeated, it is determined that none of the suspicious tasks is problematic (i.e., No in Step S45→S46), and thus, no suspicious tasks are left consequently. In such a case, it is possible to either finish the operation of the function 4 upon determination that no infinite loop operation has occurred, or start a state for executing the above-mentioned function 6 upon determination that the ping-pong phenomenon may have occurred. It is possible to set either alternative arbitrarily.

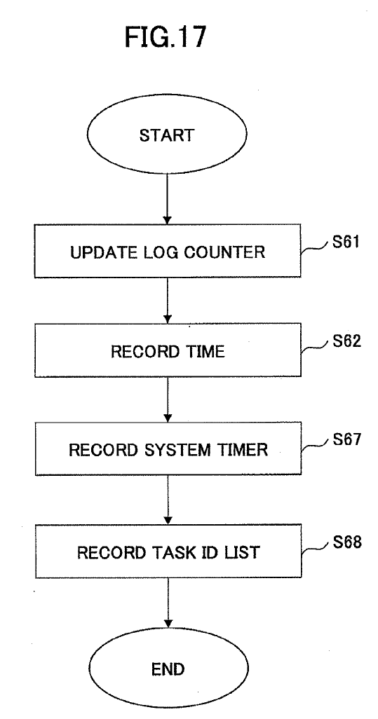

The above-mentioned function 5 (F5) is a logging function (Step S41 of FIG. 15) executed immediately after the start of the execution of the function 4. The function 5 executes operation of a flow chart of FIG. 17.

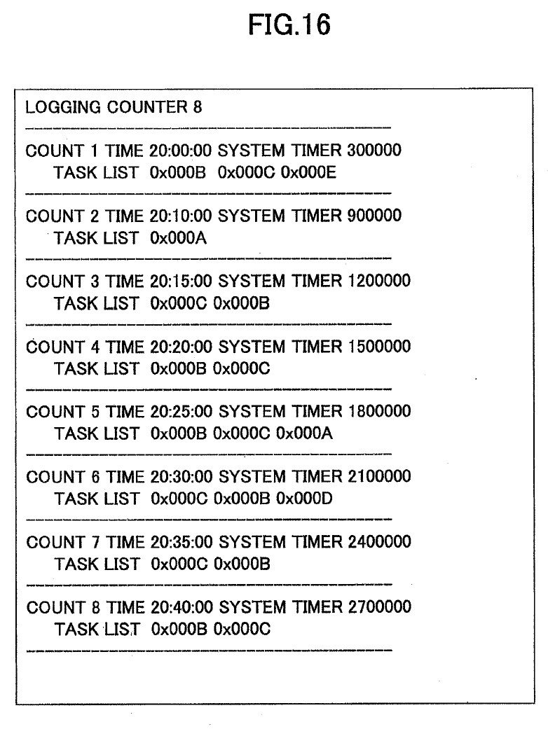

In this logging function, logging information as shown in FIG. 16 is recorded. At the top of the logging information of FIG. 16, a logging counter is provided for indicating how many times the function 5 is executed. Counting up thereof is carried out each execution of the function 5 (Step S61 of FIG. 17).

In each time of the logging operation, updating of the counter (Counter) (Step S61), recording of the apparatus time (Time) (Step S62), recording of the apparatus system time (SystemTimer) (Step S67) and recording of the suspicious task list (TaskList) at the time (Step S68) are carried out at once.

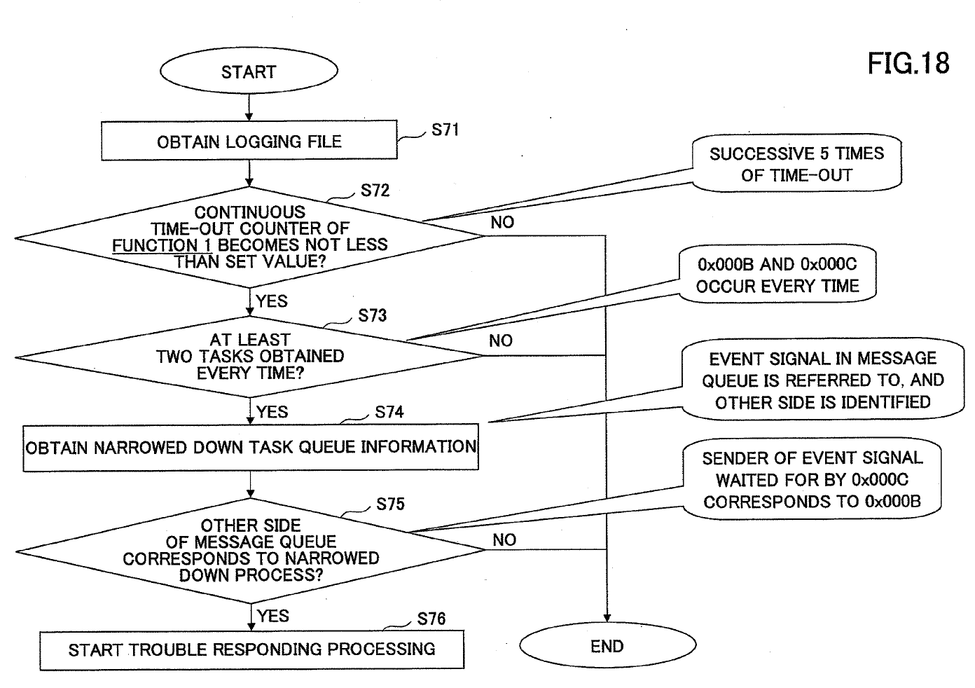

The above-mentioned function 6 (F6) is a function to determine whether or not the ping-pong phenomenon has occurred, when the function 4 determines that no infinite loop operation has occurred. This function 6 executes operation of a flow chart shown in FIG. 18.

In FIG. 18, first, the count value of the above-mentioned continuous time-out counter, counted up in Step S5 of FIG. 9 by the function 1, are read (Step S71). In Step S72, it is determined whether or not the count value thus read has reached successive 5 times of time-out corresponding to total 25 minutes set as a predetermined high load-state continuation time. When the count value has not reached the successive 5 times of time-out (No), it is determined that the continuation time is relatively short, and the execution of function 6 is finished. That is, it is determined that no ping-pong phenomenon has occurred. On the other hand, when the count value has reached the successive 5 times of time-out (Yes), Step S73 is executed.

In Step S73, in the logging information recorded by means of the execution of the function 5, the last 5 times of the logs are read, and it is determined whether or not the same task ID occurs every time there.

In the example of FIG. 16, after from the log of Counter 3, specific two tasks 0x000B and 0x000C occur every time. Accordingly, the requirements of Step S73 are met (Yes).

When no plurality of tasks meeting the requirements of Step S73 can be found out (No), it is determined that no ping-pong phenomenon has occurred, and the execution of the function 6 is finished. On the other hand, when a plurality of tasks meeting the requirements have been found out, Step S74 is executed.

In Step S74, the tasks found out in Step S73 are regarded as ping-pong suspicious tasks. That is, in this example, the tasks 0x000B and 0x000C are regarded as the ping-pong suspicious tasks. After that, the states of these ping-pong suspicious tasks are analyzed.

In this example, the task states of the above-mentioned tasks 0x000B and 0x000C are obtained. At this time, for example, the above-mentioned get_pcb function is used, and the queue information of the corresponding signals are read. In the queue, messages transmitted to the tasks are stored, and the transmission source information of each message is read. When the transmission source task of the message thus read corresponds to the respective one of the ping-pong suspicious tasks, i.e., the tasks of 0x000B and 0x000C in this example (Yes in Step S75), this means that these ping-pong suspicious tasks exchange the messages therebetween. Accordingly, in this case, it is determined that the ping-pong phenomenon has actually occurred. As a result, the previously set trouble responding processing is started (Step S76).

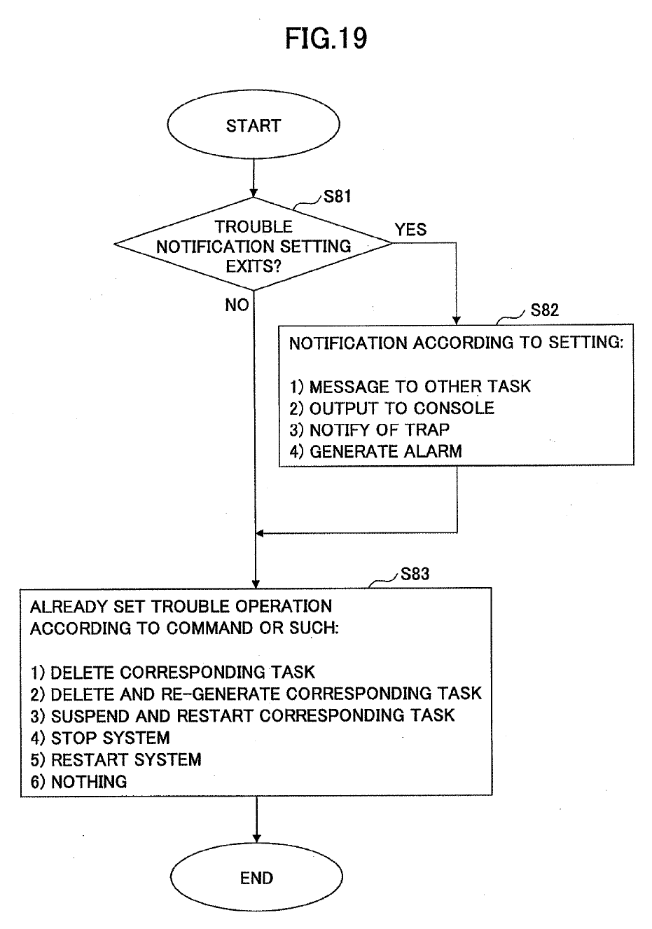

In the trouble responding processing, operation of a flow chart of FIG. 19 is executed.

First, setting as to whether or not the trouble contents should be notified of, is read (Step S81). When the notification is required (Yes), notifying processing according to setting previously made by a command is carried out (Step S82). After that, designated predetermined trouble operation is executed (Step S83).

Below, a list of parameters set for execution of each of the above-mentioned functions 1 through 6 is shown, as well as specific set values in the embodiment are shown enclosed by brackets:

Function 1:

the continuous time-out counter (started from 0);

the keep alive notification generating period (10 seconds);

the set time in the timer (5 minutes)

Function 2:

the set maximum number of times of logging (2000)

Function 3:

the set number of the list highest tasks to extract (6);

the CPU occupancy threshold (15%)

Function 4:

the set times in the check counter (600 times);

the retry waiting time (100 milliseconds)

Function 5:

none

Function 6:

the function valid/invalid setting (valid);

the set high load-state continuation time (25 minutes=5 histories)

Next, the settings in the above-mentioned trouble responding processing are shown below:

Trouble responding processing:

the notification required/non-required setting (required);

the specific notification method (the following item 2) is selected):

1) notify to another task;

2) output to the consol;

3) make a trap (TRAP) notification;

4) generate an alarm (ALM)

Trouble operation (the following item 5) is selected):

1) delete the trouble task;

2) delete and re-generate the trouble task;

3) suspend the trouble task and start operation thereof again;

4) stop the system;

5) restart the system;

6) do nothing

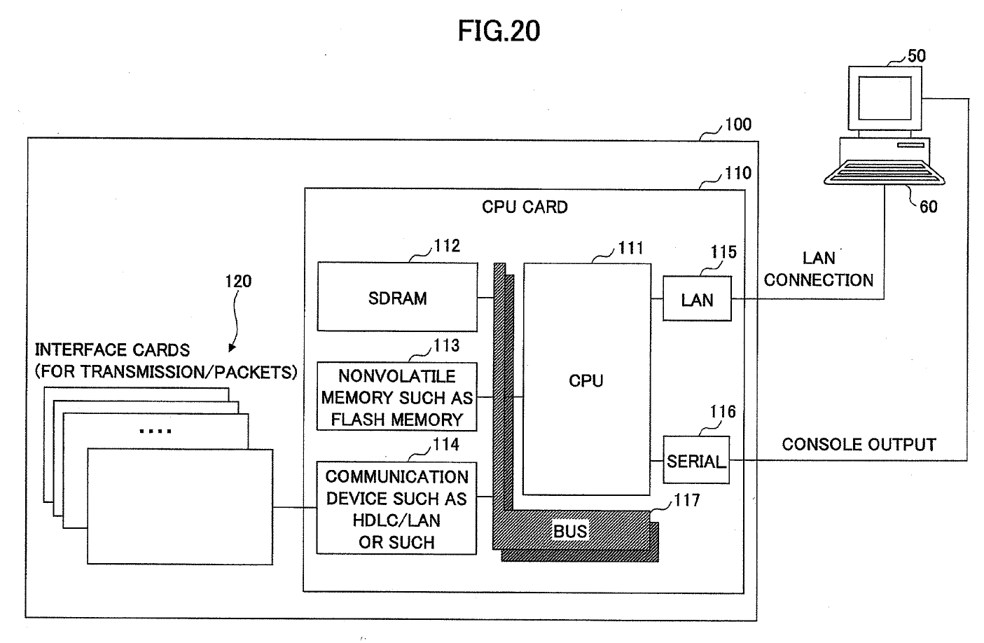

FIG. 20 shows a hardware configuration example of an information processing apparatus to which the above-described embodiment of the present invention is applicable.

As shown in FIG. 20, the information processing apparatus is made of a computer 100, which has a CPU card 110 mounting a CPU 111 executing an OS and an application program to carry out corresponding operation; a LAN interface 115 for communication with a keyboard 60; a serial interface 115 for communication with a display 50 such as a CRT, a liquid crystal display device or such; a SDRAM 12 for reading/writing the program, data or such; a nonvolatile memory 113 such as a flash memory for storing the various application programs or such; communication devices 114 such as those for HDLC, LAN or such for communication externally via a communication network and buses 117 connecting thereamong, as well as various interface cards 120 connected with the above-mentioned communication devices 114.

The OS of the computer 100 is a multitask OS, and has the above-mentioned functions i), ii), iii) and iv).

Further, the above-described trouble task detecting program in the embodiment of the present invention is stored in the nonvolatile memory 113 such as the flash memory, or downloaded through the network via the interface card 120 and the communication device 114, and then, is stored in the SDRAM 12.

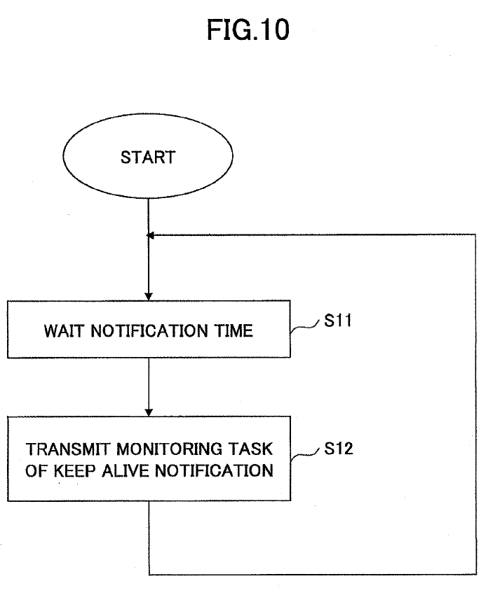

After that, the CPU 111 executes the trouble task detecting program, and thus, executes out the above-mentioned functions 1 through 6 described above with reference to FIGS. 2 through 19.

The present invention may also be applied for an OS not only of a stand-alone computer, but also various built-in OS for computers provided for controlling an automobile and so forth.

The present invention is not limited to the above-described embodiment, and variations and modifications may be made without departing from the basic concept of the present invention claimed below.

The present application is based on Japanese Priority Application No. 2006-285343, filed on Oct. 19, 2006, the entire contents of which are hereby incorporated herein by reference.

What is claimed is:

1. An information processing apparatus having a multitask operating system, comprising:
a high-load continuation detecting part detecting continuation of a high-load state of a CPU;
a task switching history storing part storing a history of task switching operation; and
a trouble task candidate extracting part extracting candidates for a trouble task which causes the continuation of the high-load state of the CPU by referring to the history of the task switching operation stored by said task switching history storing part when the continuation of the high-load state of the CPU is detected by said high-load continuation detecting part.

2. The information processing apparatus as claimed in claim 1, further comprising:
a trouble task detecting part detecting the trouble task by monitoring operations of the tasks of the candidates for the trouble task extracted by said trouble task candidate extracting part.

3. The information processing apparatus as claimed in claim 1, wherein:
said high-load continuation detecting part detects the continuation of the high-load state from a time for which the CPU continues a 100% load state.

4. The information processing apparatus as claimed in claim 1, wherein:
the history stored by said task switching history storing part comprises corresponding task identification information and task switching operation occurrence times.

5. The information processing apparatus as claimed in claim 1, wherein:
said trouble task candidate extracting part extracts the trouble task candidates with the use of total execution times of the tasks as indexes.

6. The information processing apparatus as claimed in claim 2, wherein:
said trouble task detecting part periodically monitors the states of the tasks of the candidates for the trouble task extracted by said trouble task candidate extracting part, and detects whether or not the tasks enter infinite loop operation states.

7. The information processing apparatus as claimed in claim 2, wherein:
said trouble task detecting part excludes all the tasks from the candidates for the trouble task, when the load of the CPU falls.

8. The information processing apparatus as claimed in claim 2, wherein:
said trouble task detecting part excludes the task from the candidates for the trouble task when said task enters a waiting state.

9. The information processing apparatus as claimed in claim 1, further comprising:
a ping-pong phenomenon detecting part detecting occurrence of a ping-pong phenomenon by detecting continuation of message exchange between a plurality of specific tasks of the candidates for the trouble task extracted by said trouble task candidate extracting part.

10. A control method for an information processing apparatus having a multitask operating system, comprising:
a high-load continuation detecting step of detecting continuation of a high-load state of a CPU;
a task switching history storing step of storing a history of task switching operation; and
a trouble task candidate extracting step of extracting candidates for a trouble task which causes the continuation of the high-load state of the CPU by referring to the history of the task switching operation stored in said task switching history storing step when the continuation of the high-load state of the CPU is detected in said high-load continuation detecting step.

11. The control method for the information processing apparatus as claimed in claim 10, further comprising:
a trouble task detecting step of detecting the trouble task by monitoring operations of the tasks of the candidates for the trouble task extracted in said trouble task candidate extracting step.

12. The control method for the information processing apparatus as claimed in claim 10, wherein:
said high-load continuation detecting step detects the continuation of the high-load state from a time for which the CPU continues a 100% load state.

13. The control method for the information processing apparatus as claimed in claim 10, wherein:
the history stored in said task switching history storing step comprises corresponding task identification information and task switching operation occurrence times.

14. The control method for the information processing apparatus as claimed in claim 10, wherein:
said trouble task candidate extracting step extracts the trouble task candidates with the use of total execution times of the tasks as indexes.

15. The control method for the information processing apparatus as claimed in claim 11, wherein:
said trouble task detecting step periodically monitors the states of the tasks of the candidates for the trouble task extracted in said trouble task candidate extracting step, and detects whether or not the tasks enter infinite loop operation states.

16. The control method for the information processing apparatus as claimed in claim 11, wherein:
said trouble task detecting step excludes all the tasks from the candidates for the trouble task, when the load of the CPU falls.

17. The control method for the information processing apparatus as claimed in claim 11, wherein:
said trouble task detecting step excludes the task from the candidates for the trouble task when said task enters a waiting state.

18. The control method for the information processing apparatus as claimed in claim 10, further comprising:
a ping-pong phenomenon detecting step of detecting occurrence of a ping-pong phenomenon by detecting continuation of a message exchange between a plurality of specific tasks of the candidates for the trouble task extracted in said trouble task candidate extracting step.

19. A program for causing a computer to execute control of an information processing apparatus having a multitask operating system, comprising instructions for causing the computer to execute:
a high-load continuation detecting step of detecting continuation of a high-load state of a CPU;
a task switching history storing step of storing a history of task switching operation; and
a trouble task candidate extracting step of extracting candidates for a trouble task which causes the continuation of the high-load state of the CPU by referring to the history of the task switching operation stored in said task switching history storing step when the continuation of the high-load state of the CPU is detected in said high-load continuation detecting step.

20. The program as claimed in claim 19, further comprising instructions to cause the CPU to execute:
a trouble task detecting step of detecting the trouble task by monitoring operations of the tasks of the candidates for the trouble task extracted in said trouble task candidate extracting step.
